(19) United States
(12) Patent Application Publication
(10) Pub. No.: US 2023/0211196 A1
(43) Pub. Date: Jul. 6, 2023

(54) DEVICE FOR EXTINGUISHING FIRE OR LIMITING FIRE OUTBREAKS

(71) Applicant: HUTCHINSON, Paris (FR)

(72) Inventors: Maxime ANDRE (deceased), (US); Eric BOSSARD, La Selle En Hermoy (FR); Katia ROSSI, Collegno (IT)

(21) Appl. No.: 17/998,925

(22) PCT Filed: May 18, 2021
(86) PCT No.: PCT/EP2021/063183

§ 371 Date: Nov. 15, 2022

(30) Foreign Application Priority Data
May 20, 2020 (FR) 2005223

(51) Int. Cl. A62C 35/10; A62C 3/16

(52) U.S. Cl. CPC A62C 35/10; A62C 3/16; F16L 2011/047

(57) ABSTRACT

A fire extinguishing device is for a motor vehicle. The fire extinguishing device includes an internal cavity containing a pressurized fire extinguishing fluid. The cavity is delimited by a wall, the wall having at least one barrier layer (b) containing a semi-aromatic polyamide composition (B).

### TECHNICAL FIELD OF THE INVENTION

The present invention relates to the field of extinguishing a fire or limiting a fire departure. The invention is particularly suited but not limited to its application in the field of the vehicles or motor vehicles and in particular in the field of the batteries or battery packs for such vehicles or machines. It is also suitable for its application in the field of domestic apparatus, in particular in the field of tumble dryers.

### TECHNICAL BACKGROUND

It is advantageous to equip a motor vehicle, in particular a motor vehicle with a device for automatically extinguishing a fire or a fire departure. This device is usually self-contained in that it reacts directly to the heat generated by this fire or fire departure.

In the current technology, several solutions are proposed but are not always feasible and in particular not industrialisable.

Some solutions involve the use of a storage container for extinguishing fluid, which is in the form of a bottle or cylinder. The disadvantage of these solutions is the overall dimension and the weight using this type of container.

Other solutions use a simple extinguishing hose, i.e. a hose that contains a pressurised extinguishing fluid and whose ends are closed, i.e. not connected to a storage container. In other words, the only volume of extinguishing fluid available is that stored in the extinguishing hose.

The document WO-A1-91/08022 describes an extinguishing hose of this type. The hose is produced of a thermoplastic material, in this case polyamide 12 (PA12). In the event of a fire, the thermoplastic material softens and the internal pressure causes the hose to rupture so that the extinguishing fluid escapes from the hose and is applied directly to the source of the fire.

The document WO 2015/045195 also describes an extinguishing hose delimited by a multilayer wall consisting of a barrier layer based on an ethylene vinyl alcohol copolymer (EVOH), interposed between two layers of thermoplastic material, in particular based on a polyolefin.

However, the inventors have shown that the permeability of these thermoplastic materials to fire extinguishing agents is not satisfactory and does not allow the fire extinguishing agent to be stored over the long term, thus negatively impacting the effectiveness of the product.

### SUMMARY OF THE INVENTION

The inventors have now discovered that semi-aromatic polyamides can be advantageously used as a barrier layer to fire extinguishing agents contained in the fire extinguishing devices. In particular, it has been shown that their use considerably allows to reduce the permeability to fire extinguishing agents and thus improves storage, and increases both the efficiency and the reliability of the device in the long term. As a result, this solution also has the advantage of allowing to improve the environmental impact compared to the existing extinguishing devices.

The invention has several aspects.

According to a first aspect, the invention relates to a fire extinguishing device, in particular for a motor vehicle, comprising an internal cavity containing a fire extinguishing fluid, said cavity being delimited by a wall, characterised in that said wall comprises at least one barrier layer (b) containing a semi-aromatic polyamide composition (B).

Barrier Layer (b)

By “barrier layer” is meant the layer constituting the innermost wall of the fire extinguishing device according to the invention. This includes in particular the layer that is in direct contact with the extinguishing fluid, contained in the cavity.

According to one embodiment, the semi-aromatic polyamide composition (B) contains a semi-aromatic polyamide containing at least one semi-aromatic polyamide (B1) containing aliphatic diamine units in C6-C12.

According to another embodiment, the semi-aromatic polyamide composition (B) contains a semi-aromatic polyamide (B1) containing terephthalic acid and/or naphthalene dicarboxylic acid units, preferably terephthalic acid units.

Preferably, the semi-aromatic polyamide (B1) represents at least 60% by weight of the total weight of the semi-aromatic polyamide composition.

According to a preferred embodiment, the semi-aromatic polyamide (B1) is a polyphthalamide (PPA), in particular selected from PA6T, PA9T, PA10T and PA12T.

According to one alternative embodiment, it may be a semi-aromatic polymer composition (B) as described in the document US 2019/0091962.

Thus, according to a particular embodiment, the semi-aromatic polymer composition (B) comprises a semi-aromatic polymer (B1) or a semi-aromatic polymer (B2).

The semi-aromatic polymer (B1) or the semi-aromatic polymer (B2) represents at least 60% by weight of the semi-aromatic polymer composition.

The semi-aromatic polymer (B1) comprising at least 50% in number of moles of aliphatic diamine in C9 or C10 units based on the number of moles of all the diamine units in the semi-aromatic polymer (B1), and at least 50% in number of moles of terephthalic acid units and/or naphthalenedicarboxylic acid units based on the total mole number of all dicarboxylic acid units in the semi-aromatic polymer (B1).

The semi-aromatic polymer (B2) comprising at least 50% in mole number of xylylene diamine and/or bis(aminomethyl)naphthalene units based on the mole number of all the diamine units in the semi-aromatic polymer (B2), and at least 50% in mole numbers of aliphatic dicarboxylic acid in C9 or C10 units based on the total mole numbers of all the dicarboxylic acid units in the semi-aromatic polymer (B2).

According to another embodiment, the semi-aromatic polyamide composition (B) comprises an elastomer (E).

The elastomer (E) may in particular be an elastomer comprising structural units derived from unsaturated compounds having a carboxylic and/or anhydrous acid group.

It may be present in the composition (B) in an amount of not less than 5% by weight and not more than 30% by weight.

External Layer (a)

In one embodiment, the wall delimiting the cavity of the device further comprises an external layer (a).

“External layer” means the layer constituting the wall located furthest outside the cavity delimited by the wall. The external layer is thus not in direct contact with the extinguishing fluid contained under pressure inside the cavity.

The external layer (a) preferably comprises a thermoplastic polymer composition.

This thermoplastic polymer composition may comprise an aliphatic polyamide composition (A), preferably comprising an aliphatic polyamide (A1) in C6-C12, in particular polyamide 12 (PA12).

According to one embodiment, the thermoplastic polymer composition comprises an elastomer (E).

According to a particular embodiment, the aliphatic polyamide composition (A) comprises:
an aliphatic polyamide (A1), which is an aliphatic polyamide having a number of methylene groups based on the number of amide groups of not less than 0.8 and is contained in the composition (A) in an amount of not less than 40% by weight and not more than 90% by weight,
An aliphatic polyamide (A2), which is a polymer distinct from the polyamide (A1) and is contained in the composition (A) in an amount of not less than 5% by weight and not more than 30% by weight,
An elastomeric polymer (E) comprising structural units derived from unsaturated compounds having a carboxylic and/or anhydrous acid group, and is contained in the composition (A) in an amount of not less than 5% by weight and not more than 30% by weight.

In one alternative embodiment, the aliphatic polyamide composition (A) is as described in the document US 2019/0091962.

Thus, more particularly, the aliphatic polyamide composition (A) may comprise:
an aliphatic polyamide (A1), which is an aliphatic polyamide having a number of methylene groups based on the number of amide groups of not less than 0.8 and is contained in the composition (A) in an amount of not less than 40% by weight and not more than 90% by weight,
An aliphatic polyamide (A2), which is a polymer distinct from the polyamide (A1) and is contained in the composition (A) in an amount of not less than 5% by weight and not more than 30% by weight,
An elastomeric polymer (E) comprising structural units derived from unsaturated compounds having a carboxylic and/or anhydrous acid group, and is contained in the composition (A) in an amount of not less than 5% by weight and not more than 30% by weight,
The difference in absolute value between the solubility parameter PS of polyamide (A1) and that of polyamide (A2) [I(PS of polyamide (A1))−PS of polyamide (A2)I] is not less than 1.8 (MPa)^{1/2} and not more than 5.5 (MPa)^{1/2}.

The term “solubility parameter” refers to the definition commonly used in the field, i.e. the square root of the cohesive energy related to the molar volume.

The aliphatic polyamide (A1) is in particular a homopolymer, in particular selected from the group consisting of polyhexamethylene dodecamide (polyamide 612), polynonamethylene dodecamide (polyamide 912), polydecamethylene sebacamide (polyamide 1010) polydecamethylene dodecamide (polyamide 1012), polydodecamethylene dodecamide (polyamide 1212), polyundecanamide (polyamide 11) and polydodecanamide (polyamide 12), polydodecanamide (polyamide 12) being particularly preferred.

The aliphatic polyamide (A1) may be a copolymer consisting of one or more monomers constituting the homopolymers listed above.

The aliphatic polyamide (A2) is in particular a homopolymer, in particular selected from the group consisting of polycaproamide (polyamide 6), polyhexamethylene adipamide (polyamide 66), polyhexamethylene azelamide (polyamide 69), polyhexamethylene sebacamide (polyamide 610), polyhexamethylene terephthalamide (polyamide 6T), polyhexamethylene isophthalamide (polyamide 61) and polymetaxylylene adipamide (polyamide MXD6).

The aliphatic polyamide (A2) may be a copolymer consisting of one or more monomers constituting the homopolymers listed above, or a copolymer based on a monomer chosen from the monomers constituting at least one polymer chosen from the group consisting of polycaproamide (polyamide 6), polyhexamethylene adipamide (polyamide 66), polyhexamethylene azeleamide (polyamide 69), polyhexamethylene sebacamide (polyamide 610), polyhexamethylene terephthalamide (polyamide 6T), polyhexamethylene isophthalamide (polyamide 61) and polymetaxylylene adipamide (polyamide MXD6), polyhexamethylene dodecamide (polyamide 612), polynonamethylene dodecamide (polyamide 912) polydecamethylene sebacamide (polyamide 1010), polydecamethylene dodecamide (polyamide 1012), polydodecamethylene dodecamide (polyamide 1212), polyundecanamide (polyamide 11) and polydodecanamide (polyamide 12).

In one embodiment, the external layer (a) is adjacent to the barrier layer (b).

According to the present description, two layers are referred to as “adjacent” if they are in direct contact with each other.

Intermediate Layer (c)

In another embodiment, the wall comprises an intermediate layer (c) between the barrier layer (b) and the external layer (a).

The intermediate layer (c) may in particular comprise a thermoplastic polymer composition.

The thermoplastic polymer composition may in particular comprise an aliphatic polyamide composition (A), preferably comprising an aliphatic polyamide (A1) in C6-C12, in particular polyamide 12 (PA12).

The thermoplastic polymer composition may comprise an elastomer (E).

In one alternative embodiment, the aliphatic polyamide composition (A) is as described in the document US 2019/0091962.

Thus, more particularly, the aliphatic polyamide composition (A) may comprise:
an aliphatic polyamide (A1), which is an aliphatic polyamide having a number of methylene groups based on the number of amide groups of not less than 0.8 and is contained in the composition (A) in an amount of not less than 40% by weight and not more than 90% by weight,
An aliphatic polyamide (A2), which is a polymer distinct from the polyamide (A1) and is contained in the composition (A) in an amount of not less than 5% by weight and not more than 30% by weight,
An elastomeric polymer (E) comprising structural units derived from unsaturated compounds having a carboxylic and/or anhydrous acid group, and is contained in the composition (A) in an amount of not less than 5% by weight and not more than 30% by weight,
The difference in absolute value between the solubility parameter PS of polyamide (A1) and that of polyamide (A2) [I(PS of polyamide (A1))−PS of polyamide (A2)I] is not less than 1.8 (MPa)^{1/2} and not more than 5.5 (MPa)^{1/2}.

In one embodiment, the thermoplastic polymer composition of the intermediate layer (c) comprises an ethylene vinyl alcohol copolymer (EVOH).

In yet another embodiment, the wall comprises:
A first adhesive layer (d₁) interposed between the barrier layer (b) and the intermediate layer (c), making the connection between the layers (b) and (c); and/or
A second adhesive layer (d₂), interposed between the intermediate layer (c) and the external layer (a), making the connection between the layer (c) and the layer (a).

According to a particular embodiment, the wall comprises an intermediate layer (c) comprising EVOH and two adhesive layers (d₁) and (d₂) as defined above.

The adhesive layers (d₁) or (d₂) may in particular comprise a polyolefin or a terpolyamide PA6/66/12,

According to one embodiment, the wall comprises a barrier layer (b), an intermediate layer (c), and an external layer (a), the latter of which may comprise a thermoplastic polymer composition, in particular an aliphatic polyamide in C6-C12, more particularly polyamide 12.

In a preferred embodiment, the intermediate layer (c) is adjacent to the barrier layer (b).

In another preferred embodiment, the intermediate layer (c) is adjacent to the external layer (a).

In another preferred embodiment, the wall comprises:
a barrier layer (b) comprising a polyphthalamide (PPA), in particular PA9T,
an intermediate layer (c) comprising an aliphatic polyamide in C6-C12, in particular polyamide 12, and an elastomer (E);
an external layer (a) comprising an aliphatic polyamide in C6-C12, in particular polyamide 12.

The thickness of the individual layers is not particularly limited and may vary, depending on the nature of the polymers constituting the individual layers, the total number of layers composing the wall, the conditions of use, in particular the melting conditions of the wall or the desired mechanical properties.

The thickness of each of the layers is determined in particular by the barrier properties with respect to the extinguishing fluid contained in the cavity, the resistance to impact at low temperatures, and the flexibility of the wall. As a general rule, the thickness of the layers (a) and/or (b) is between 3% and 90% of the total thickness of the wall. For a better compromise between the low-temperature impact resistance and the barrier properties to the extinguishing fluid, the thickness of the barrier layer (b) is generally between 5% and 50% of the total thickness of the wall, and preferably between 7% and 30%.

The number of layers constituting the wall is not particularly limited, as long as there is at least one barrier layer (b). The wall may comprise additional layers, other than layers (a), (b), (c), (d₁) or (d₂), in particular additional thermoplastic layers, in particular to modulate the mechanical properties of the device.

The nature, the number and the thickness of the various layers constituting the wall are chosen in particular so as to obtain a material, in particular a multilayer material, with the following properties:
a melting temperature equal to K, so that said extinguishing fluid can be released when the wall is subjected to a temperature equal to or greater than K, and
an elongation at rupture of 30% or less at a temperature below K, so that said extinguishing fluid can be released when the wall is mechanically constrained,

K being between 45° C. and 120° C., under ambient temperature and pressure conditions.

“Ambient conditions of temperature and pressure” means a temperature of 25° C. and a pressure of 1 bar.

Extinguishing Fluid

The wall delimiting the cavity of the device, and comprising in particular the layers (b), (b)/(a), (b)/(c)/(a), and (b)/(d₁)/(c)/(d₂)/(a), is fusible under the effect of the heat generated by a fire or a fire departure. This allows the release of the extinguishing fluid stored in the cavity as soon as a fire or a fire departure occurs.

The purpose of the extinguishing fluid contained in the cavity delimited by the wall defined above is to extinguish a fire or a fire departure. It is generally dielectric and advantageously free of moisture.

The extinguishing fluid contained in the cavity of the device is within the operating conditions of the device.

In one embodiment, the extinguishing fluid is in a gaseous state. In particular, it is under pressure.

In particular, the extinguishing fluid can be stored in the above-mentioned cavity at a pressure in the range of 5 to 7 bar, at room temperature.

In one embodiment, the extinguishing fluid is in the liquid state and has a boiling temperature of 25° C. or more, in particular 45° C. or more, and in particular 120° C. or more, under the ambient temperature and pressure conditions.

The extinguishing fluid may comprise in particular at least one gas HFC and/or C₆F₁₂O, and/or CO₂.

According to one embodiment, said gas HFC is selected from HFC236, R227ea and R125.

The extinguishing fluid preferably does not comprise gas HFC of the type R236Fa because this gas has a very high PWP (Planetary Warming Potential) or GWP (Global Warming Potential) of around 9400.

The extinguishing fluid preferably has a PWP or GWP of 5000 or less. The fluid may comprise at least one gas HFC and/or C₆F₁₂O, and/or CO₂. Among the gases HFC that can be used, the gases R227ea and R125 are preferred as they have an PWP or GWP of around 3400-3500. The company DuPont, for example, markets such gases under the names FE-25 and FM-200.

CO₂ is advantageous because it has a PWP or GWP of 1.

Finally, C₆F₁₂O is also advantageous because it has a PWP or GWP of 1. The company 3M markets in particular this type of gas under the name Novec 1230 (FK-5-1-12).

According to a preferred embodiment, the device according to the invention is characterised in that it is in the form of a hollow tubular structure.

In a particular embodiment of the invention, the hose has an external diameter of between 10 and 30 mm, and preferably between 10 and 20 mm. The wall thickness is between 1 and 3 mm, preferably between 1 and 2 mm.

In an alternative embodiment, the device is in the form of a battery pack case.

More particularly, this case defines an internal cavity for housing a plurality of rechargeable electric battery cells arranged side by side, said cavity, delimited by a wall, being sealed and filled with an extinguishing fluid, characterised in that said wall comprises a barrier layer (b) comprising a semi-aromatic polyamide as defined above.

In an alternative embodiment, the device comprises at least one pressure sensor configured to measure the pressure of said fluid in said cavity.

In one embodiment, said at least one sensor is connected to remote communication means.

The battery pack, the device or the hose may be equipped with a pressure sensor for the extinguishing fluid. This pressure sensor is advantageously connected to remote communication means such as RFID or radio. For example, during a maintenance operation of the vehicle, an operator can read the pressure in the cavity of the hose with appropriate equipment by simply passing this equipment near an RFID tag or a radio transmitter arranged on the hose.

In a preferred embodiment, the remote communication means co-operate with elements of the vehicle to alert the driver of the vehicle of a fault. This is the case, for example, when the pressure in the cavity is too low for the hose to be operational and to extinguish a fire or a fire departure. In this case, the driver of the vehicle could be alerted by a warning light on the dashboard that the hose is faulty and needs to undergo a maintenance operation by replacing it or refilling it with fluid at a correct pressure. In such a case, the electronics of the vehicle could be configured to put the vehicle into a shutdown or degraded mode discouraging the driver from using the vehicle, until the hose undergoes this maintenance operation.

Alternatively, the above-mentioned elements of the vehicle could be connected to the pressure sensor of the hose by a wire connection.

The battery pack, the device or the hose can be operated as follows. When a fire or fire departure occurs in a vehicle, heat is generated. The battery cells can heat up and expand, as described above. They can then mechanically stress devices or walls of the case, which will then rupture and release extinguishing fluid. At a certain temperature, for example above 70 or even 120° C., the devices or fusible walls of the case will soften and break due to the pressure inside the hose. The extinguishing fluid is then released and sprayed directly onto the fire to cause it to be extinguished immediately and thus prevent its spread.

According to yet another embodiment, the invention relates to a battery pack, in particular for a motor vehicle, comprising a fire extinguishing device as defined above, said device being in particular in the form of a hollow tubular structure or a case, said tubular structure or case containing an extinguishing fluid in their internal cavity.

According to an embodiment, the battery pack comprises a case defining an internal cavity for housing a plurality of rechargeable electric battery cells arranged side by side, said cavity, delimited by a wall, being sealed and filled with an extinguishing fluid, characterised in that said wall comprises a barrier layer (b) comprising a semi-aromatic polyamide as defined above.

The extinguishing fluid is thus in direct contact with the battery cells.

The fluid may be in gaseous or liquid form. In the latter case, the battery cells are flooded or immersed in the extinguishing fluid. The volume of extinguishing fluid contained in the battery pack is for example greater than 1 L.

According to another embodiment, the invention relates to a motor vehicle, comprising at least one fire extinguishing device as defined in the present description.

According to yet another embodiment, the invention relates to a domestic apparatus, in particular a tumble dryer comprising at least one fire extinguishing device as defined in the present description.

The device according to the invention may comprise one or more of the following characteristics, taken alone or in combination with each other:
the extinguishing fluid is in a gaseous state.
the extinguishing fluid is in the liquid state and has a boiling temperature of 45° C. or more, and preferably 120° C. or more,
the extinguishing fluid has a PWP or GWP of 5000 or less,
the extinguishing fluid comprises at least one HFC gas and/or C₆F₁₂O, and/or CO₂,
said HFC gas is selected from R227ea and R125,
the device comprises at least one pressure sensor configured to measure the pressure of said fluid in said cavity,
said at least one sensor is connected to remote communication means,
at least some of the devices zigzag between the battery cells,
at least some of the devices are wrapped around the battery cells,
at least some devices extend between two adjacent battery cells,
at least some of the devices form a lattice,
at least one of the devices is an elongated hose with both longitudinal ends closed,
at least one of the devices is a sleeve through which one of the battery cells passes,
at least one of the devices comprises an area of mechanical weakness such that the device breaks down in this area as a result of mechanical stress,
said wall extends over or under a plurality of battery cells,
said wall extends next to several battery cells,
said wall forms a cover or a bottom of said case,
said wall forms a rib or a partition projecting into said cavity,
the wall comprises an area of mechanical weakness so that it breaks down in this area as a result of mechanical stress,
said wall comprises a number of internal spaces,
the or each space extends predominantly in a plane substantially parallel to the plane of the wall comprising that space,
the device is in the form of an elongated tubular hose with both longitudinal ends closed,
the device is in the form of a sleeve,
the device is in the form of a case wall or a case,
the device is preformed by thermoforming to a shape corresponding to that in a desired installation position, for example in said vehicle.
the extinguishing fluid may be liquid or gaseous at atmospheric pressure and ambient temperature; it is advantageously gaseous when it is intended to extinguish a fire or a fire departure; it may therefore be liquid at atmospheric pressure and ambient temperature and become gaseous at a temperature greater than or equal to 50° C., for example, as is the case with C₆F₁₂O,
said longitudinal ends are closed by plugs which are fitted and attached, for example by press-fitting or welding,
the device comprises a fluid admission and/or evacuation port, for example at a first of its longitudinal ends,
the device comprises a fluid admission and/or evacuation port, for example at a second of its longitudinal ends,
a fluid admission and/or evacuation port is located away from the longitudinal ends of the hose,
the or each port comprises a flap valve, the valve comprising a flap which is solicited by an elastic member into a sealed position in said space, and which is movable from that closed position to an open position when a fluid is supplied to the space through the port and has a pressure greater than that of the pressure in the space.

As examples of configurations of extinguishing devices according to the invention, and in particular of configurations of battery packs comprising an extinguishing device according to the invention, reference may be made in particular to the applications FR 3 088 209, FR 3 088 210, FR 3 088 211, FR 3 088 212, FR 3 088 213, FR 3 088 214, FR 3 088 215.

### FIGURE

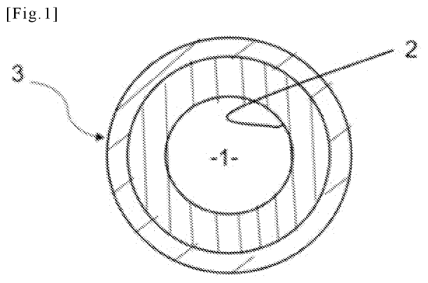

FIG. 1 shows the cross-section of an example of a fire extinguishing device according to the invention in a tubular form with a double-layer wall comprising:
a barrier layer (2), and
an external layer (3) ensuring in particular a good mechanical behaviour.

The internal cavity (1) delimited by the double-layer wall contains a fire extinguishing fluid.

### EXAMPLES

Materials and Methods

In the following examples 1 and 2, the burst pressure of different hose structures at different temperatures and their permeability were investigated.

The sealed test hoses (1, 2 and 3) of known and identical dimensions (400 mm long tube, 15 mm internal diameter, 18 mm external diameter, end fittings), each equipped with a different type of barrier layer, were filled to 80% with a fire extinguishing fluid (HFC236) and maintained for a given time at a given temperature. Empty sealed hoses were used as control samples.

The 3 hose structures tested have a wall thickness of 1.5 mm. They have a distinct composition, in particular different barrier layers.

Hose 1: the barrier layer is a 0.3 mm thick PA9T layer

Hose 2: The barrier layer is a 0.25 mm thick EVOH layer. The adhesive between the layers EVOH and the PA12 is a PA612 copolyamide.

Hose 3: this structure does not comprise a barrier layer. It is a single layer of PA612, 1.5 mm thick.

### Example 1: Fusible Nature of the Hoses 1, 2 and 3

In order to assess the ability of the hoses to release the extinguishing fluid in the event of a fire departure, burst tests of the 3 walls were carried out in accordance with the standard SAE J2260.

The results are presented in Table 1 below.

TABLE 1

| | | | Bursting | Bursting |
|---|---|---|---|---|
| | Internal/external | | pressure | pressure |
| | diameter | Structure | at 80° C. | at 125° C. |
| Hose | (mm)/(mm) | of the wall | [bar] | [bar] |
| 1 | 15/18 | PA9T/PA12 | 40.4 | 26.1 |
| 2 | 15/18 | PA6/EVOH/adh/PA12 | 42 | 28.5 |
| 3 | 15/18 | PA6.12 | 35.8 | 28.8 |

It is noted that the wall structures tested have a property of melting at a greater or lesser pressure, under the combined effect of heat and the rise in pressure of the extinguishing fluid, and in particular under the effect of a temperature greater than or equal to 80° C., or even 125° C.

### Example 2: Permeability Nature of the Hoses 1, 2 and 3

In order to assess the permeability of the different hose structures (1, 2 and 3), the weight of the test hoses was measured at regular time intervals at the set working temperature, until a steady state was reached, i.e. a stage where the weight of the test hoses no longer varied (deviation of less than 10% from the lowest value of the last 4 measurements).

The table below shows the results of the permeability test for hoses produced with different multi-layer walls.

The permeability tests were carried out at 80° C., at atmospheric pressure and at a wall thickness of approximately 1.5 mm.

The results obtained after a period of 25 days are as follows.

TABLE 2

| | | Permeability |
|---|---|---|
| | | HFC236 - 80° C. |
| Hose | Type | [g/m/an] |
| 1 | PA9T/PA12 | 2 |
| 2 | PA6/EVOH/adh/PA12 | 2.8 |
| 3 | PA612 | 8.8 |

These results show that the wall 1 containing a PA9T/PA12 barrier layer has a permeability lower than 30% than that of the wall 2 containing an EVOH-based barrier layer and more than 4 times lower than that of the wall 3.

Consequently, the results show that for a fusibility nature equivalent to that of the wall 2, the wall 1, equipped with a barrier layer based on a semi-aromatic polyamide, will allow better storage of the extinguishing fluid over time and thus improve the efficiency of the fire extinguishing device.

1. A fire extinguishing device, comprising an internal cavity containing a fire extinguishing fluid, said cavity being delimited by a wall, wherein said wall comprises at least one barrier layer containing a semi-aromatic polyamide composition.

2. The device according to claim 1, wherein the semi-aromatic polyamide composition contains at least one semi-aromatic polyamide containing aliphatic diamine units in C6 to C12.

3. The device according to claim 1, wherein the semi-aromatic polyamide composition contains a semi-aromatic polyamide containing terephthalic acid and/or naphthalene dicarboxylic acid units.

4. The device according to claim 1, wherein the semi-aromatic polyamide is a polyphthalamide.

5. The device according to claim 1, wherein the polyphthalamide is selected from PA6T, PA9T, PA1 OT and PA12T.

6. The device according to claim 1, wherein the wall further comprises an external layer.

7. The device of claim 6, wherein the external layer comprises a thermoplastic polymer composition.

8. The device according to claim 7, wherein the thermoplastic polymer composition comprises an aliphatic polyamide composition.

9. The device of claim 8, wherein the thermoplastic composition comprises an elastomer.

10. The device as claimed in claim 6, wherein the external layer is adjacent to the barrier layer.

11. The device of claim 8, wherein the wall comprises an intermediate layer between the barrier layer and the external layer.

12. The device of claim 11, wherein the intermediate layer comprises a thermoplastic polymer composition.

13. The device of claim 12, wherein the thermoplastic polymer composition of the intermediate layer comprises an elastomer.

14. The device of claim 12, wherein the thermoplastic polymer composition of the intermediate layer comprises an ethylene vinyl alcohol copolymer.

15. The device according to claim 11, wherein the external layer comprises a thermoplastic polymer composition.

16. The device of claim 11, wherein the intermediate layer is adjacent to the barrier layer.

17. The device of claim 16, wherein the intermediate layer is adjacent to the external layer.

18. The device according to claim 15, wherein the wall comprises:
a barrier layer comprising a polyphthalamide,
an intermediate layer comprising an aliphatic polyamide in C6-C12;
an external layer comprising an aliphatic polyamide in C6-C12.

19. The device according to claim 1, comprising a hollow tubular structure.

20. A battery pack comprising a fire extinguishing device as defined in claim 1.

21. A motor vehicle, comprising at least one fire extinguishing device according to claim 1.

22. A domestic apparatus, comprising at least one fire extinguishing device according to claim 1.

23. A motor vehicle, comprising a battery pack according to claim 20.
